(19) United States
(12) Patent Application Publication
(10) Pub. No.: US 2018/0190053 A1
(43) Pub. Date: Jul. 5, 2018

(54) BLUETOOTH SENSING METHOD AND SYSTEM FOR UNLOCKING A DOOR

(71) Applicant: ORZDAR TECH INC., HSINCHU CITY (TW)

(72) Inventors: PEI-TZU WU, HSINCHU CITY (TW); BING-HENG LI, KAOHSIUNG CITY (TW); CHIEN-HAU HUNG, HSINCHU CITY (TW); TSUNG-YEN YANG, PINGTUNG COUNTY (TW); WEI JOU DUH, TAIPEI (TW); PEI-HSUAN TSAI, KAOHSIUNG CITY (TW)

(21) Appl. No.: 15/479,724

(22) Filed: Apr. 5, 2017

(30) Foreign Application Priority Data
Dec. 30, 2016 (TW) 105144228

(51) Int. Cl. G07C 9/00; H04W 4/00; H04W 76/02

(52) U.S. Cl. CPC G07C 9/00309; H04W 4/008; H04M 2250/02; G07C 2209/63; G07C 2009/00404; H04W 76/023

(57) ABSTRACT

A Bluetooth sensing method for unlocking a door, applied to a system including an electronic device, an electronic door lock, and an authenticator connected to the electronic door lock. The method includes: the electronic device detecting that the distance between the electronic device and the authenticator is smaller than a pre-defined value, the electronic device setting up a Bluetooth communication connection to the authenticator; the processor initiates a mutual authentication process to the controller when the distance is smaller than a pre-defined value; the electronic device automatically transmitting an unlocking instruction to the authenticator; and the authenticator unlocking the electronic door lock according to the unlocking instruction.

### BACKGROUND OF THE INVENTION

### 1. Field of the Invention

The instant disclosure relates to a method and a system for unlocking a door; in particular, to a Bluetooth sensing method and system for unlocking a door.

### 2. Description of Related Art

Electronic door locks are unlocked by several sensing methods, like electro-magnetic, RFID, or NFC tokens, together with traditional physical keys; users may forget to bring key or sensing tokens. However, with the popularity of portable smart electronic devices (such as smart phone, tablet, watches, . . . , etc.), almost everyone carries smart electronic device in daily life. Users may forget to bring key token, but would unlikely forget to bring their smart electronic device; thus the integration of key token and smart electronic device brings significant benefit for users. Bluetooth technology is the most popular one in current smart electronics devices, and will still the most important RF technology in the next decades. Existing electronic door locks, which adopted Bluetooth technology, requires users to launch software applications (i.e. App) on smart phone, and manually unlock the door. It requires users to take out the smart phone from bag and then multiple finger taps to do the work. In this invention, no finger tap is required and users just use smart phone as sensing token and no need to bring extra key token any more.

### SUMMARY OF THE INVENTION

The instant disclosure provides a Bluetooth sensing method and system for unlocking a door. A user can bring a Bluetooth-enabled electronic device close to an electronic door lock to unlock the door, and the electronic device automatically senses and unlocks an electronic door lock within a pre-defined distance. Not only does this solve the problem of a user forgetting to bring the key token, but also overcomes a disadvantage that personal electronic devices are rarely integrated with the existing key token, so that only the Bluetooth function of the electronic device is needed to complete sensing and unlocking of the electronic door lock.

An exemplary embodiment of the instant disclosure provides a Bluetooth sensing method for unlocking a door, applied to a system which includes an electronic device, an electronic door lock, and an authenticator. The electronic device includes a processor and a first Bluetooth Module; the authenticator electrically connects to the electronic door lock, and includes a controller and a second Bluetooth Module. The method includes: the processor detecting the distance between the electronic device and the authenticator via the first Bluetooth module; when the distance between the electronic device and the authenticator is smaller than a pre-defined value, the processor instructing the first Bluetooth module to connect with the second Bluetooth module and the processor initiates mutual authentications between electronic devices and the authenticator through the first Bluetooth module and the second Bluetooth module; after mutual authentication is passed, the processor automatically sends an unlocking instruction to the second Bluetooth module via the first Bluetooth module; and the controller unlocking the electronic door lock according to the unlocking instruction.

An exemplary embodiment of the instant disclosure provides a Bluetooth sensing system for unlocking a door, including: an electronic door lock; an electronic device including a processor and a first Bluetooth module; and an authenticator including a controller and a second Bluetooth module, and being electrically connected to the electronic door lock; When the processor detects that the distance between the electronic device and the authenticator is smaller than a pre-defined value via the first Bluetooth module, the processor instructs the first Bluetooth module to connect to the second Bluetooth module and the processor initiates mutual authentications between electronic device and the authenticator through the first Bluetooth module and the second Bluetooth module; after mutual authentication is passed, the processor then automatically sends an unlocking instruction to the second Bluetooth module via the first Bluetooth module, and the controller unlocks the electronic door lock according to the unlocking instruction.

The Bluetooth sensing method and system for unlocking a door of the instant disclosure allows the user to use a more convenient way for unlocking the door, namely that the user can use the Bluetooth sensing method of the electronic device to unlock the door, no need to bring an extra key token, no need to go through multiple taps on smart phone APPs to unlock the door.

For further understanding of the instant disclosure, reference is made to the following detailed description illustrating the embodiments of the instant disclosure. The description is only for illustrating the instant disclosure, not for limiting the scope of the claims.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a diagram of a Bluetooth sensing system for unlocking a door according to the instant disclosure from outside of the door;

FIG. 2 shows a diagram of a Bluetooth sensing system for unlocking a door according to the instant disclosure from inside of the door;

FIG. 3 shows a flow chart of a Bluetooth sensing method for calibrating and unlocking a door according to the instant disclosure; and

FIG. 4 shows a diagram illustrating different statuses of an electronic door lock of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, third, and the like, may be used herein to describe various elements, but these elements should not be limited by these terms. These terms are only to distinguish one element, component, region, layer, or section from another element, component, region, layer, or section discussed below. Thus, a first element, component, region, layer, or section discussed below could be termed a second element, component, region, layer, or section without departing from the teachings of the instant disclosure. As used herein, the term “and/or” includes any and all combinations of one or more of the associated listed items.

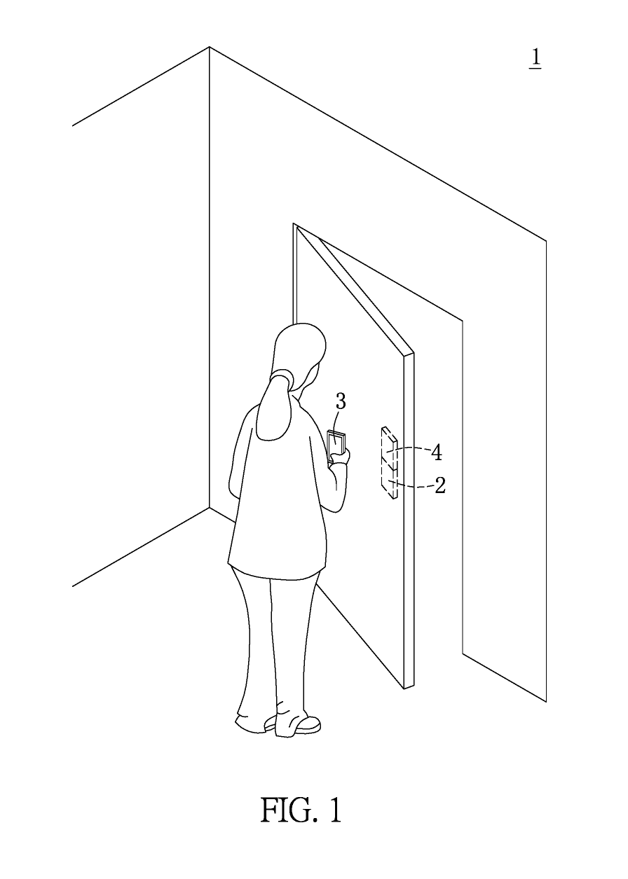

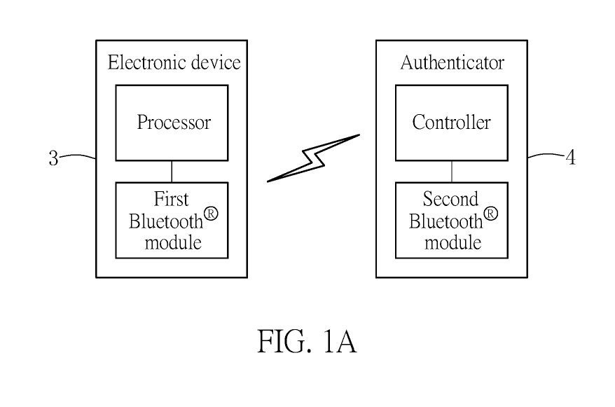

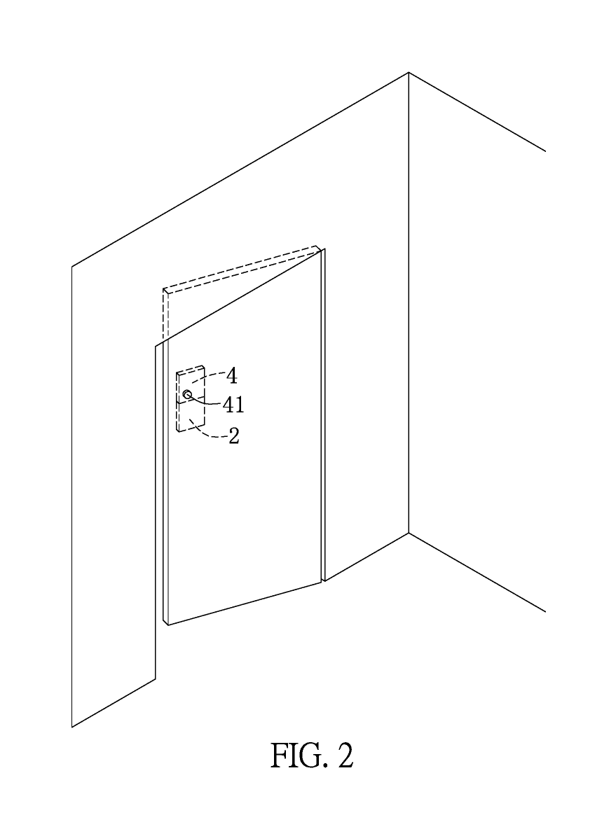

FIG. 1 shows a Bluetooth sensing system for unlocking a door according to the instant disclosure from outside of the door. The Bluetooth sensing system 1 for unlocking the door includes an electronic door lock 2, an electronic device 3, and an authenticator 4 that is connected to the electronic door lock 2. The electronic device 3, such as a smart mobile phone, a tablet, a standalone key token, and so on, includes a processor and a first Bluetooth module connected to the processor. The processor of the electronic device 3 executes an application software to unlock the door via Bluetooth. The electronic door lock 2 and the authenticator 4 are fitted on the door. That is, the electronic door lock 2 and the authenticator 4 are embedded in the door, and only a keyhole (not shown) is exposed from the electronic door lock 2 to prevent housebreakers from unlocking the door by breaking the authenticator 4. The authenticator 4 may also be fitted on a wall adjacent to the door, but the instant disclosure is not limited thereto. The authenticator 4 includes a controller and a second Bluetooth module connected to the controller. FIG. 2 shows a Bluetooth sensing system for unlocking a door according to the instant disclosure. At the back of the authenticator 4 further includes a button 41. The electronic device 3 should be paired with the authenticator 4 via the Bluetooth before electronic device 3 can perform the sensing unlock function. To pair electronic devices 3 and the authenticator 4, a user launches the application software (APP) on the electronic device 3 and presses the button 41 of the authenticator 4 from inside of the door in order to start the pairing process through the connection between the first Bluetooth module and the second Bluetooth module. The Bluetooth pairing may refer to a normal Bluetooth pairing, or other proprietary protocols that may link the electronic device 3 and the authenticator 4, the instant disclosure not being limited thereto.

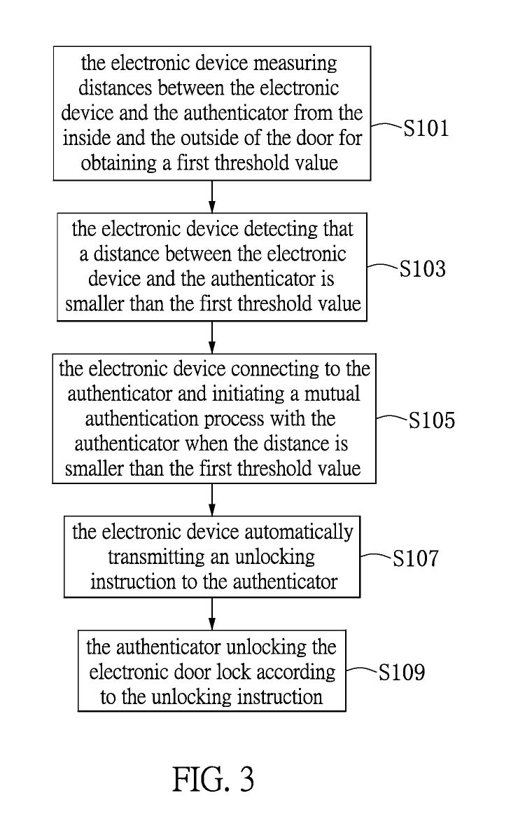

FIG. 3 shows a flow chart of a Bluetooth sensing method for unlocking a door of the instant disclosure. Calibration (S101) is a step to accommodate the effect of several related factors, such as different Bluetooth modules, antenna effects, environment interferences, and so on, and to improve the precision of the distance sensing. At Calibration stage (S101), the user puts electronic device 3 at pre-defined positions (both indoor and outdoor) and the application software (APP) computes and obtains an internal calibration value, which will be used to improve the precision at distance detection. The Bluetooth sensing method to unlock a door starts from S103: the electronic device 3 detecting that a distance between the electronic device 3 and the authenticator 4 is smaller than the first threshold value; S105: the electronic device 3 connecting to the authenticator 4 and initiating a mutual authentication process with the authenticator 4 when the distance is smaller than the first threshold value; S107: the electronic device 3 automatically transmitting an unlocking instruction to the authenticator 4; S109: the authenticator 4 unlocking the electronic door lock 2 according to the unlocking instruction; where the first threshold value is a distance between the electronic device 3 and the authenticator 4.

After the Bluetooth pairing between the electronic device 3 and the authenticator 4, the processor of the electronic device 3 initiates the Calibration step (S101) to obtain the first threshold value (TH1) and stores the paired information and TH1 in a storage of the electronic device 3, such as RAM, memory card, and so on. It is worth noting that a received signal strength indicator (RSSI) of a Bluetooth signal between the electronic device 3 and the authenticator 4 are different due to different distances between the electronic device 3 and the authenticator 4 from the inside and the outside of the door. Even if the distance between the electronic device 3 and the authenticator 4 is fixed, the RSSI of the Bluetooth signal may not be stable. Different electronic devices that are at a same distance with the authenticator 4 may also have different RSSI. Thus, the application of the electronic device 3 held by the user executes a measuring program which guides the user to move to several positions for measuring the RSSI of the Bluetooth signal until completion of the program. When the electronic device 3 and the authenticator 4 are in different environments, the RSSI of the Bluetooth signal may be affected by the different environments. Some environments require only one measurement, while others require multiple measurements. The instant disclosure does not limit the means and the number of the measurements made. The application software (APP) running on the electronic device 3 executes the measuring procedure to obtain the first threshold value, which is the distance corresponding to the RSSI of the Bluetooth signal, so that the instant disclosure unlocks the door via the Bluetooth according to the first threshold value. In order to shield the RSSI of the Bluetooth signal between the electronic device 3 and the authenticator 4 and accidentally unlocking the door from the inside, such as the user unintentionally bringing the electronic device 3 close to the back of the authenticator 4, the distances between the electronic device 3 and the authenticator 4 needs to be measured, or a shield structure may be equipped, such as a metal shell, to the back of the authenticator 4 for avoiding the unintentional activation of the authenticator 4. In this embodiment, the processor of the electronic device 3 measures the distances between the electronic device 3 and the authenticator 4 from the inside and the outside of the door for obtaining a first threshold value (for example, 5 cm), but this value may be varied and is not limited to that disclosed herein.

It is worth noting that after the Bluetooth pairing between the electronic device 3 and the authenticator 4, the user does not need to execute the step of S101 immediately. The user may execute the step of S101 only when the user wishes to unlock the electronic door lock 2 via the Bluetooth or to increase the accuracy of the Bluetooth sensing. Thus, step S101 is executed at least once before the electronic door lock 2 can be unlocked via Bluetooth sensing. The instant disclosure does not limit the number of times that step S101 is executed.

When the user is gradually approaches the door from the outside and uses the electronic device 3 to unlock the electronic door lock 2, the processor of the electronic device 3 detects the Bluetooth signal of the second Bluetooth module of the authenticator 4 via the first Bluetooth module, and the application software of the electronic device detects that the distance between the electronic device 3 and the authenticator 4 becomes gradually shorter. For example, when the distance between the electronic device 3 and the authenticator 4 is 10 cm, the application of the electronic device detects that the distance between the electronic device 3 and the authenticator 4 is 10 cm.

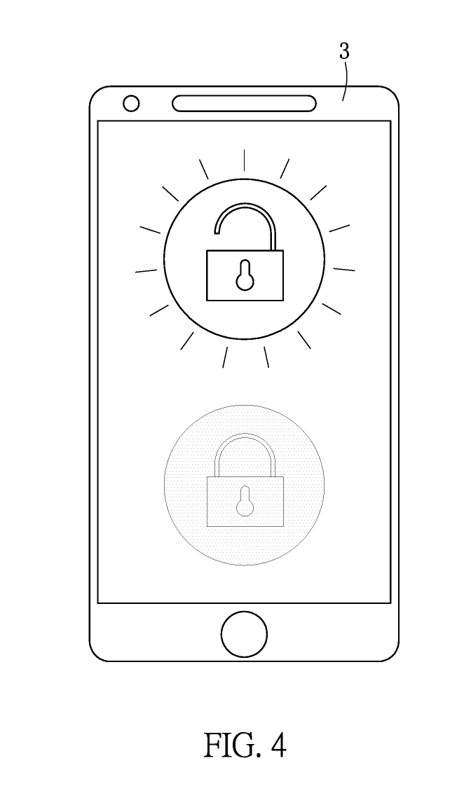

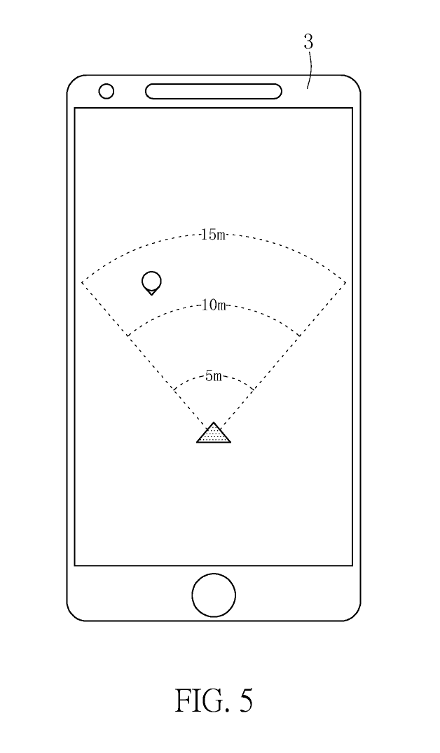

In steps S103 and S105, the processor of the electronic device 3 detects that the distance between the first Bluetooth module of the electronic device 3 and the second Bluetooth module of the authenticator 4 is smaller than the first threshold value. Accordingly, the processor of the electronic device 3 instructs the first Bluetooth module to connect to the second Bluetooth module of the authenticator 4, and then the processor of the electronic device 3 initiates a mutual authentication process with the controller of the authenticator 4. If the authentication fails, the controller of the authentication 4 instructs the second Bluetooth module to disconnect with the first Bluetooth module immediately. As shown in FIG. 4, if the authentication is successful, the controller of the authenticator 4 provides the locked/unlocked status of the electronic door lock 2 to the first Bluetooth module of the electronic device 3, so that the application software (APP) of the electronic device 3 can display the locked/unlocked status of the electronic door lock 2 on a display of the electronic device 3. The connection and authentication processes of Bluetooth may also refer to a variety of other protocols that link the electronic device 3 and the authenticator 4 to achieve a secure and mutual authentication mechanism, and thus the instant disclosure is not limited thereto.

In step S107, the user brings the electronic device 3 close to the authenticator 4 within the pre-defined range (for example, 5 cm). The processor of the electronic device 3 detects that the distance between the first Bluetooth module of the electronic device 3 and the second Bluetooth module of the authenticator 4 is smaller than the first threshold value (for example, 5 cm). The processor of the electronic device 3 then automatically transmits an unlocking instruction to the second Bluetooth module of the authentication 4 via the first Bluetooth module.

In step S109, the second Bluetooth module of the authenticator 4 receives the unlocking instruction, and then the controller of the authenticator 4 unlocks the electronic door lock 2 according to the unlocking instruction.

In an embodiment of the instant disclosure, the user executes the application software (APP) on the electronic device 3 and presses the button 41 of the authenticator 4 for the Bluetooth pairing between the electronic device 3 and the authenticator 4 inside of the door, so that the authenticator 4 is paired with the electronic device 3. At Calibration stage, the application software (APP) running on the electronic device 3 executes a measuring function to obtain the first threshold value, and stores the first threshold value in the storage of the electronic device 3. When the user gradually approaches the door from outside of the door and wishes to unlock the door, the first Bluetooth module of the electronic device 3 detects the Bluetooth signal from the second Bluetooth module of the authenticator 4 and the APP running on the electronic device 3 detects the distance between the electronic device 3 and the authenticator 4. When the electronic device 3 is positioned close to the authenticator 4 within a pre-defined range, (for example, 5 cm), the first Bluetooth module of the electronic device 3 establishes a connection to the second Bluetooth module of the authenticator 4 and the processor of electronic device 3 initiates a mutual authentication process with the authenticator 4. When the authentication is successful, the processor of the electronic device 3 automatically transmits the unlocking instruction to the second Bluetooth module and the controller of the authenticator 4 via the first Bluetooth module, and the controller of the authenticator 4 unlocks the electronic door lock 2.

Based on the above-mentioned, the Bluetooth sensing method and system for unlock a door of the instant disclosure allows the user to use convenient means for unlocking the door, namely that the user can use the Bluetooth sensing method of the electronic device to unlock the door, without the need for bringing extra key tokens. It is thus achieved that the user can take the electronic device close to the authenticator to unlock the door, and the electronic device automatically senses and unlocks an electronic door lock at a pre-defined distance. Not only does this solve the problem of a user forgetting to bring the key token, but also overcomes a disadvantage that electronic devices are rarely integrated with the key token, so that only the Bluetooth function of the electronic device is needed to complete sensing and unlocking of the electronic door lock.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

1. A Bluetooth® sensing method for unlocking a door, applied to a system including an electronic device, an electronic door lock, and an authenticator, the electronic device including a processor and a first Bluetooth® module, the authenticator being electrically connected to the electronic door lock, and including a controller and a second Bluetooth® module, the method comprising:
the processor detecting whether a distance between the electronic device and the authenticator is smaller than a first threshold value via the first Bluetooth® module;
the processor instructing the first Bluetooth® module to connect with the second Bluetooth® module and initiating a mutual authentication with the controller via the communication link established between the first Bluetooth® module and the second Bluetooth® module when the distance is smaller than the first threshold value;
the processor automatically transmitting an unlocking instruction to the second Bluetooth® module via the first Bluetooth® module; and
the controller unlocking the electronic door lock according to the unlocking instruction.

2. The method according to claim 1, wherein the electronic door lock is fitted on the door, the authenticator includes a button which is on the inside of the door and pressed to pair the electronic device and the authenticator via the first Bluetooth® module and the second Bluetooth® module.

3. The method according to claim 1, wherein when the processor detects the authenticator via the first Bluetooth® module, the electronic device includes a display to show the distance between the electronic device and the authenticator.

4. The method according to claim 1, wherein when the processor detects the authenticator via the first Bluetooth® module, the electronic device is a standalone key token.

5. The method according to claim 1, further comprising:
the processor measuring distances between the electronic device and the authenticator from inside and outside of the door for obtaining the first threshold value.

6. A Bluetooth® sensing system for unlocking a door, comprising:
an electronic door lock;
an electronic device, the electronic device including a processor and a first Bluetooth® module; and
an authenticator, the authenticator including a controller and a second Bluetooth module, and being electrically connected the electronic door lock;
wherein the processor detects whether the distance between the electronic device and the authenticator is smaller than a first threshold value via the first Bluetooth® module, the processor instructs the first Bluetooth® module to connect with the second Bluetooth® module and the processor initiates a mutual authentication with the controller via the communication link established between the first Bluetooth® module and the second Bluetooth® module when the distance is smaller than the first threshold value; the processor automatically transmits an unlocking instruction to the second Bluetooth® module via the first Bluetooth® module, the controller unlocks the electronic door lock according to the unlocking instruction.

7. The system according to claim 6, wherein the electronic door lock is fitted on the door, the authenticator includes a button which is on the inside of the door and pressed to pair the electronic device and the authenticator via the first Bluetooth® module and the second Bluetooth® module.

8. The system according to claim 6, wherein the electronic device includes a display to show the distance between the electronic device and the authenticator when the processor detects the authenticator via the first Bluetooth® module.

9. The system according to claim 6, wherein the electronic device is a standalone key token.

10. The system according to claim 6, wherein the processor measures distances between the electronic device and the authenticator from the inside and the outside of the door for obtaining the first threshold value.
